(19) United States
(12) Patent Application Publication
(10) Pub. No.: US 2017/0354297 A1
(43) Pub. Date: Dec. 14, 2017

(54) ASSEMBLY FOR PREPARATION OF MEALS FOR INFANTS, IN PARTICULAR MEALS FOR BABIES

(71) Applicant: BABYMOOV GROUP, Clermont-Ferrand (FR)

(72) Inventor: Alexandre PEREIRA, AUBIERE (FR)

(21) Appl. No.: 15/619,919

(22) Filed: Jun. 12, 2017

(30) Foreign Application Priority Data
Jun. 13, 2016 (FR) 1655426

(51) Int. Cl. A47J 43/046; A47J 27/00; A47J 36/24; A47J 31/40; A47J 43/04; A47J 44/00

(52) U.S. Cl. CPC A47J 43/046; A47J 36/2433; A47J 31/401; A47J 27/004; A47J 44/00; A47J 43/04; A47J 31/40

(57) ABSTRACT

The invention relates to a meal preparation assembly for preparing meals for infants, that includes a first culinary preparation module, such as a mixing module, and a connection base (8; 8′) for at least the first module (6; 4′, 6′), the base being adapted to be supplied with electrical energy and including an electrical connector (90; 90′, 92) in order to connect the first module in a removable manner and to transfer the electrical energy to the first module when it is connected, this electrical connector (90; 90′, 92) being retractable. The assembly includes a second steam cooking module (4, 4′) which is separate and distinct from the first module (6; 6′) and the base includes a user interface.

### FIELD OF THE INVENTION

The invention relates to a meal preparation assembly for preparing meals for infants, that includes a base, a first culinary preparation module, such as for example a mixing module, a feeding-bottle warming module, a steriliser module and a second steam cooking module which is separate and distinct from the first module.

### BACKGROUND OF THE INVENTION

Known in the prior art is an assembly comprising a first mixing module and a second steam cooking module. In the prior art, the mixing module includes a base with an electrical connector in order to connect the second module, an electrical connection means, and a user interface with a display screen and control-command buttons. The second steam cooking module can therefore not be used alone: it must be connected into the electrical connector of the base in order to be able to function.

The aforementioned assembly includes several disadvantages. A first drawback is that the steam cooking module cannot be used alone. However, once the child outgrows the infancy stage, there is no longer a need to mix the foods. The first mixing module thus cannot be detached from the assembly, such that this assembly is relatively bulky in the kitchen. In addition, when the mixer is used alone, the electrical connector for connecting the second module remains outwardly in view. On the one hand, it is not very aesthetic and, on the other hand, this may adversely affect the proper operation of the assembly because liquid and other dirt or contaminants could infiltrate into the interior of the outwardly visible connector.

It is these drawbacks that the invention is more particularly intended to remedy by providing a meal preparation assembly for preparing meals for infants, wherein the mixing module can be detached and stored in a closet and with which the steam cooking module can be used without the mixing module.

### SUMMARY OF THE INVENTION

To this end, the invention relates to an assembly that includes a first culinary preparation module, such as a mixing module, and a connection base for at least the first module, the base being adapted to be supplied with electrical energy and including an electrical connector in order to connect the first module in a removable manner and to transfer the electrical energy to the first module when it is connected, this electrical connector being retractable. According to the invention, the assembly is a meal preparation assembly for preparing meals for infants that includes a second steam cooking module which is separate and distinct from the first module, while the base includes a user interface.

Thanks to the invention, the mixing module and the base are independent from each other. Thus, once the child outgrows the infancy stage, the mixing module can be detached from the base and stored within a closet. This frees up space on the work surface in the kitchen. In addition, when the mixing module is not in use, the electrical connector provided for its operation can be retracted, that is to say hidden or stored out of sight, in order to prevent the liquid and other dirt or contaminants from infiltrating into the interior of the connector. In addition, this is a more aesthetic arrangement.

According to aspects of the invention that are advantageous, but not obligatory, such an assembly may include one or more of the following characteristic features, taken in consideration according to any technically admissible combination:
The connector is mounted on a tray that is capable of sliding within the interior of the base.
The tray includes a gripping means.
The gripping means is a slot.
The base includes an electronic foolproofing-polarising device for recognising the type of module that is connected on to the connector.
The electronic foolproofing-polarising device is formed by micro contacts, the base then being capable of determining the specific type of module that has been connected on the basis of the particular micro contacts that are connected.
The second module and the base are not separable.
The second module or the base includes a connection means for connecting to an electrical network.
The second module can be detached from the base.

### BRIEF DESCRIPTION OF THE DRAWINGS

The invention and other advantages thereof it will become more clearly apparent in the light of the description of two embodiments of a meal preparation assembly for preparing meals for infants. This description is provided only by way of an example and with reference being made to the drawings in which:

FIG. 1 is a view in perspective representing an assembly that comprises a steam cooking module and a connection base fitted with a retractable connector for the connection of a mixing module, the connector being retracted out of sight;

FIG. 2 is a view that is analogous to that in FIG. 1, in which the connector is visible;

FIG. 3 is a view that is analogous to that in FIGS. 1 and 2, in which the mixing module is connected to the base;

FIG. 4 is a view in perspective that is comparable to that in FIG. 3, representing a meal preparation assembly for preparing meals for infants in accordance with a second embodiment of the invention, this base including two connectors for the connection of a steam cooking module and a mixing module;

FIG. 5 is a view in perspective in which the connection base shown in FIG. 4 is represented only in a configuration where the two connectors are visible;

FIG. 6 is a view that is analogous to that in FIG. 5, in which one of the two connectors is retracted out of sight;

FIG. 7 represents the connection base shown in FIG. 6 connected to the steam cooking module only.

### DETAILED DESCRIPTION OF THE INVENTION

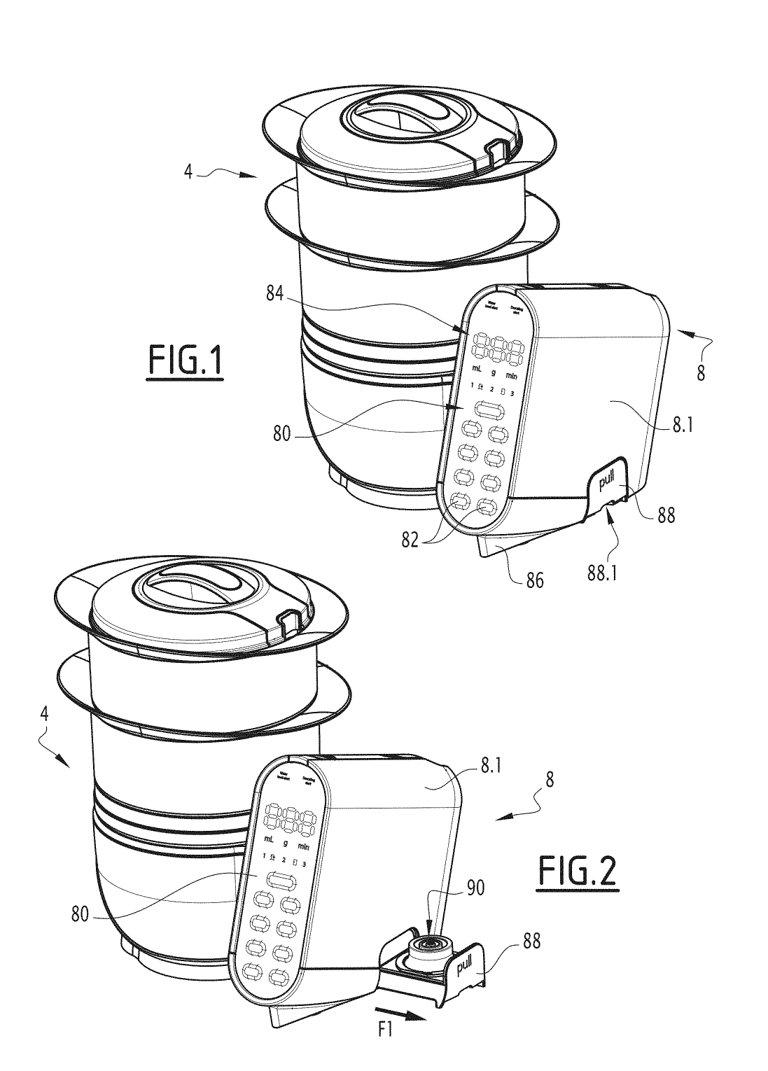

In FIGS. 1 to 3 is represented a meal preparation assembly 2 for preparing meals for infants, in particular for the preparation of meals for babies. The assembly 2 can be likened to a food processor.

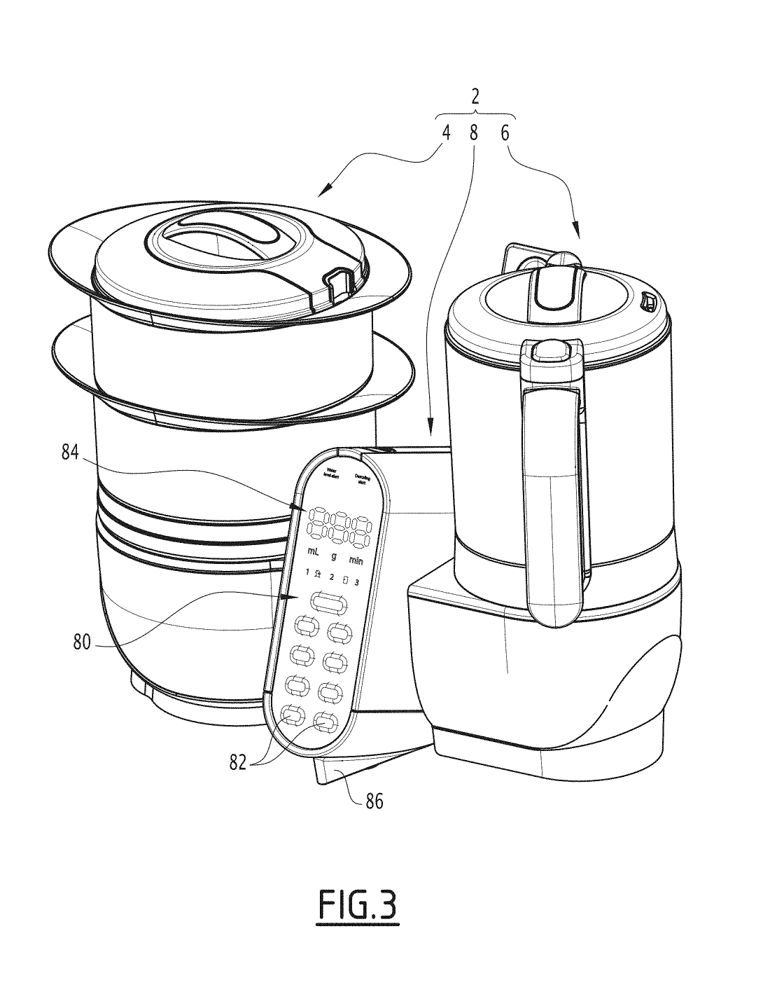

As can be seen in FIG. 3, the assembly 2 includes a first module 4 that is suitable for steam cooking the food and a second module 6 for the mixing of foodstuffs.

In this present document, the term “module” is used to refer to an electrical culinary appliance for food preparation-processing, in particular an electrical appliance used for the preparation of meals for babies.

Each of the modules 4 and 6 can be likened to a food processor that includes all the components necessary for its operation. The modules 4 and 6 are distinctly separate modules, that is to say, they cannot be considered as compartments of a single multifunction food processing appliance. In the example, the module 4 and the base 8 are not separable. The assembly 2 also includes a connection base 8 on which the mixing module 6 can be connected.

The connection base 8 includes a housing 8.1 and a user interface 80 disposed on one of the faces of the housing 8.1. This user interface 80 includes command buttons 82 and a display screen 84. The display screen 84 can be used to display the weight of the foodstuffs placed within the interior of the steam cooking module 4, or even the number of minutes required to cook the foodstuffs. The user interface 80 makes it possible to guide the user during the preparation of the meal.

The steam cooking module 4 includes a connection means for connecting to the electrical network. This connection means is an electrical power outlet that serves the purpose of connecting the end of a cable, the opposite end of the cable being configured so as to be connected into a wall outlet or on a power strip. The electrical power outlet of the module 4 is not visible in FIGS. 1 to 3 because it is located at the rear of the module 4. The connection base 8 and the steam cooking module 4 not being separable, the electrical energy drawn by module 4 on the electrical power network can be transferred to the base 8, in particular for the operation of the user interface 80.

The connection base 8 also includes a connector 90 for connecting the mixing module 6. When the mixing module 6 is connected into the base 8, the electrical energy can be transferred from the base 8 to the mixing module 6 by the connector 90. Thus, the electrical current extracted from the network is first transferred to the steam cooking module 4, then to the connection base 8 and finally to the mixing module 6. The base 8 is disposed between the two modules 4 and 6 when the mixing module 6 is connected into the connector 90 of the base 8.

As can be seen in FIG. 2, the electrical connector 90 is mounted on a sliding tray 88. The tray 88 is represented in the closed position in FIG. 1 and in the open position in FIG. 2. The electrical connector 90 is thus retractable, that is to say that it can be stored within the interior of the housing 8.1 of the base 8 when the user no longer wishes to use the mixing module 6. The mixing module 6 can therefore be stored in a cupboard in the kitchen, which frees up space on the work surface because the preparation assembly becomes less bulky. This also makes it possible to ensure that dirt or contaminants, such as dust, grease or even liquid can be prevented from dirtying the connector 90. This thus ensures the proper functioning of the device when the mixing module 6 is connected again on to the base.

Advantageously, the tray 88 includes a gripping means in order to help in the opening. In the example, this gripping means is a slot 88.1 formed in the lower part of the tray 88. However, by way of a variant, the slot 88.1 can be formed in the upper part of the tray, or even on the side. Another gripping means may also possibly be envisaged, such as a handle. The slot 88.1 is meant to enable a user to pull out the tray 88 with their finger in order to bring out the connector 90 and connect the mixing module 6.

Moreover, the base 8 advantageously includes a support 86 configured in a manner such that the user interface 80 is turned facing upwards when the base 8 is placed on a flat surface. This has the advantage of ensuring that the user interface 80 has enhanced visibility and is more accessible when the user is positioned standing up and the base 8 is positioned at mid height relative thereto, for example on the work surface in a kitchen.

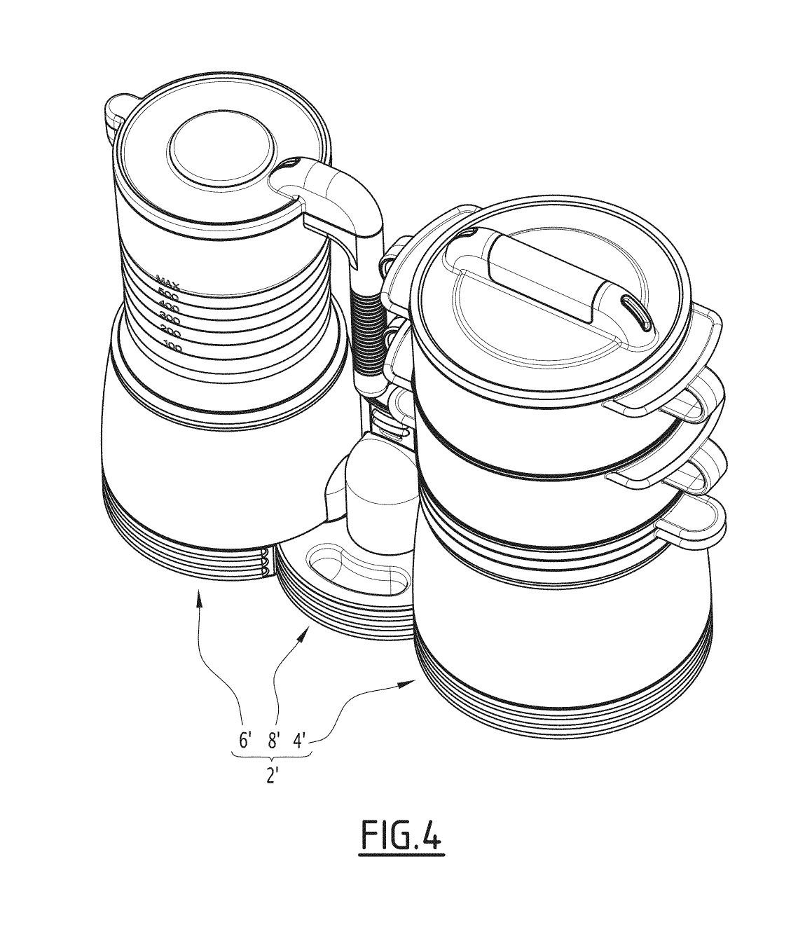

A second embodiment of a connection base 8′ is represented in FIGS. 4 to 7. In the following section, only the differences relative to the first embodiment are mentioned in the interests of brevity. In addition, the elements that are comparable to those of the first embodiment retain their (same) numerical references, however the latter are followed by a prime symbol, while the other elements carry other numerical references.

As can be seen in FIG. 4, the connection base 8′ is designed to be used for effecting the connection of a steam cooking module 4′ and a mixing module 6′. The steam cooking module 4′ and the mixing module 6′ are therefore separated from the connection base 8′.

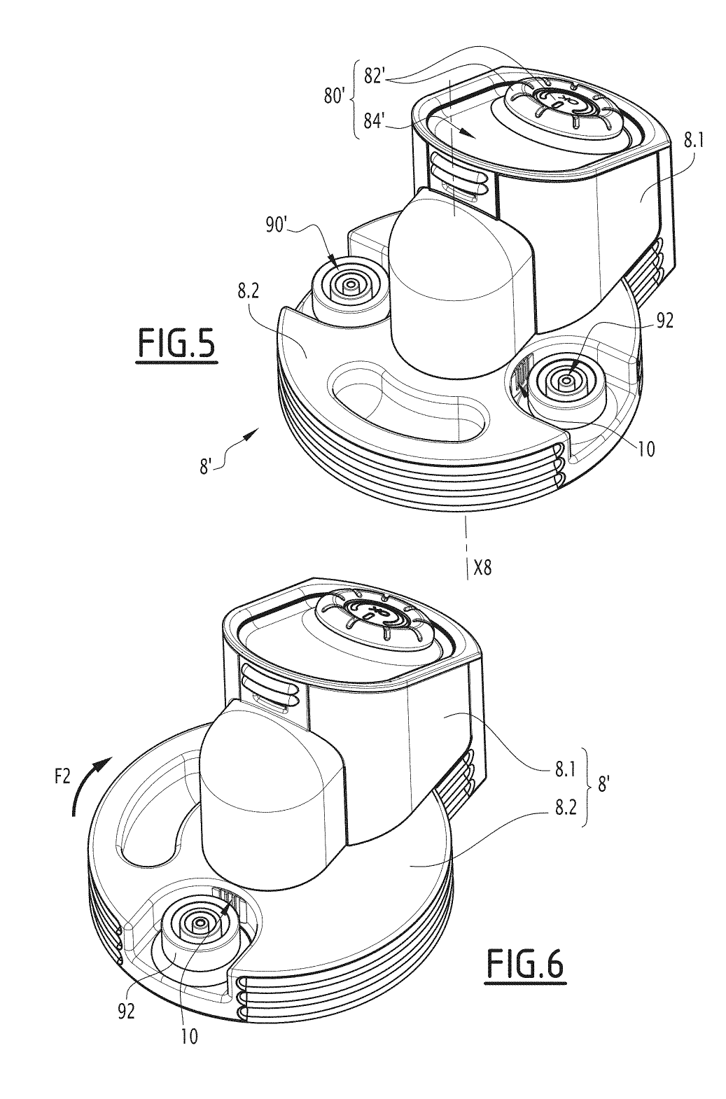

As can be seen in FIG. 5, the connection base 8′ includes a housing 8.1 and a plate 8.2. The plate 8.2 is mounted so as to be pivotable in relation to the housing 8.1 around a vertical axis X8. As in the first embodiment, the housing 8.1 includes a user interface 80′ that comprises the command buttons 82′ and a display screen 84′. In this example, the command buttons 82′ are formed by a rotating control knob and a validation button.

The rotatable plate 8.2 includes two connectors, respectively 90′ and 92, for the connection of the mixing module 6′ and the steam cooking module 4′. Advantageously, the mixing module 6′ and the steam cooking module 4′ can be connected as per the user's choice on to the connector 90′ or on to the connector 92.

Electronic foolproofing-polarising devices are provided in order to enable the connection base 8′ to recognise the type of module that is connected on to the connector 90′ or 92. It is thus possible to ensure that the electric control-command signal sent by the base 8′ to the module 4′ or 6′ is appropriate to the type of module that is connected, and in particular that the amount of electrical energy transferred by the base 8′ to the module 4′ or 6′ is adapted to the type of device. Indeed, the modules 4′ and 6′ do not have the same power consumption. In the example, the electronic polarisation is effected by means of the micro contacts 10 provided on the base 8′. Each of the micro contacts 10 is suitable and capable of cooperating with a complementary micro contact arranged on at least one of the modules. When a module is connected on the base 8′, this latter can thus then determine the type of module that is connected on the basis of the particular micro contacts 10 that are connected. This advantageously makes it possible to connect on the base 8′ any pair of modules selected from the eight distinctly separate modules.

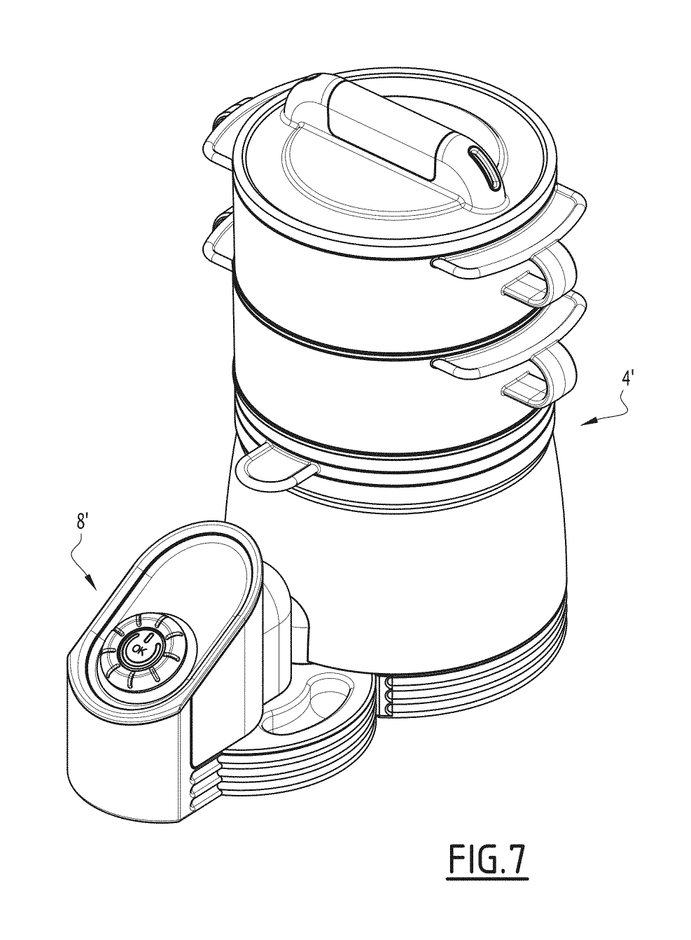

As can be seen in FIG. 6, the connector 90′ is retractable: the latter can be hidden away within the interior of the housing 8.1 by means of rotation F2 of the plate 8.2 around the axis X8. Thus, when the mixing module 6′ is no longer being used, the user pivots the plate 8.1 in order to hide the connector 90′ within the interior of the housing 8.2. This makes is possible to avoid exposing the connector 90′ to dirt and other contaminants when the mixing module 6′ is not being used.

The connection base 8′ includes a connection means for connecting to the electrical poser network. This connection means is not represented in the Figures but it is in practice an electrical power outlet provided for the connection of a cable. It may also be a cable that is not separable from the base 8′, intended to be connected into a wall outlet or on a power strip.

During the operation of the steam cooking module 4′ and/or the mixing module 6′, the electrical energy supplied by the network to the base 8′ is partially transferred, thanks to the connector 90′ and/or 92, to the steam cooking module 4′ and/or to the mixing module 6′.

By way of a variant that is not represented, and applicable to the first embodiment, the steam cooking module 4 and the connection base 8 are separated from each other. The connection base 8 then includes another tray for the connection of the steam cooking module 4. This other tray may be identical to the tray 88.

According to another variant that is not represented, and applicable to the first embodiment, the tray does not include any gripping means. A spring is then arranged in order to assist in the opening of the tray. This spring can be activated by a simple application of pressure on the part of the user, in a manner similar to the systems for opening of disk drives fitted on to computers.

According to another variant that is not represented, and applicable to the first embodiment, the tray 88 is replaced by a valve. This valve could be designed so as to be pivotable around a horizontal axis or around a vertical axis.

According to another variant that is not represented, and applicable to the first embodiment, the connection means for connecting to the electrical power network may also be integrated on to the base 8. In similar fashion, instead of an electrical power outlet, the connection means may be a cable from a single source with the module 4 or the base 8 and including one end designed to be connected into a wall power outlet or to a power strip.

According to another variant that is not represented, and applicable to the two embodiments, the connection base, respectively 8 or 8′, may be provided in order to cooperate with a number of modules that is greater than 2. It is possible for example, to envisage the connecting of a feeding-bottle warming module or even a steriliser module.

According to another variant that is not represented, and applicable to the two embodiments, the mixing module may be replaced by any other type of culinary preparation module, such as a feeding-bottle warming module, a steriliser module, a module for preparing smoothies, a centrifuge, etc. . . . . The connection base 8 according to the first embodiment could then be equipped with an electronic foolproofing-polarising device comparable to those described in relation to the second embodiment, that is to say micro contacts 10, so as to recognise the type of module that is connected from among the various different possibilities. The preparation assembly could then take the form of one base and multiple modules, which can each be connected on to the base.

The technical characteristic features of the variants and embodiments envisaged here above may be combined amongst themselves in order to generate new embodiments of the invention.

1. A meal preparation assembly for preparing meals for infants, that includes:
a first culinary preparation module, and
a connection base for at least the first culinary preparation module, the connection base being adapted to be supplied with electrical energy and including an electrical connector in order to connect the first culinary preparation module in a removable manner and to transfer the electrical energy to the first culinary preparation module when it is connected, this electrical connector being retractable,
wherein the meal preparation assembly includes a second steam cooking module which is separate and distinct from the first culinary preparation module and wherein the connection base includes a user interface.

2. A meal preparation assembly according to claim 1, in which the second steam cooking module and the connection base are not separable.

3. A meal preparation assembly according to claim 2, in which the second steam cooking module or the connection base includes a connection means for connecting to an electrical network.

4. A meal preparation assembly according to claim 1, in which the second steam cooking module can be detached from the connection base.

5. A meal preparation assembly according to claim 1, in which the electrical connector is mounted on a tray that is capable of sliding within the interior of the connection base.

6. A meal preparation assembly according to claim 5, wherein the tray includes a gripping means.

7. A meal preparation assembly according to claim 6, wherein the gripping means is a slot.

8. A meal preparation assembly according to claim 1, wherein the connection base includes an electronic foolproofing-polarising device for recognising the type of module that is connected on to the electrical connector.

9. A meal preparation assembly according to claim 8, wherein the electronic foolproofing-polarising device is formed by the micro contacts, the connection base then being capable of determining the specific type of module that has been connected on the basis of the particular micro contacts that are connected.

10. A meal preparation assembly according to claim 1, wherein the first culinary preparation module is a mixing module.
